(19) United States
(12) Patent Application Publication
(10) Pub. No.: US 2022/0135265 A1
(43) Pub. Date: May 5, 2022

(54) FILM THERMOFORMING DEVICE OF BLISTER PACKAGING MACHINE

(71) Applicant: Mutual Corporation, Osaka (JP)

(72) Inventors: Takeshi KODAI, Osaka (JP); Kensuke IKEUCHI, Osaka (JP)

(21) Appl. No.: 17/435,727

(22) PCT Filed: Mar. 13, 2019
(86) PCT No.: PCT/JP2019/010224

§ 371 Date: Sep. 2, 2021

(51) Int. Cl. B65B 47/08; B29C 51/08; B29C 51/10; B29C 51/42; B65B 11/52; B65B 47/02

(52) U.S. Cl. CPC B65B 47/08; B29C 51/08; B65B 47/02; B29C 51/42; B65B 11/52; B29C 51/10

(57) ABSTRACT

Provided is a film thermoforming device of a blister packaging machine in which molding can be carried out without extreme reduction in a sheet thickness of a top surface portion of a pocket, and without warpage, which allows stacking, and stable molding can be performed at a high rate. This film thermoforming device comprises a compressed air blowing mechanism that is disposed at a forming mold 5A and that has a compressed air blowing pore 53a which is open at an inner bottom portion of a pocket hole 52 of the forming mold 5A, and a compressed air blowing pore 53b which is open around the pocket hole 52 of the forming mold 5A.

### TECHNICAL FIELD

The present invention relates to film thermoforming methods for blister packaging machines.

### BACKGROUND ART

Conventional blister packaging for packaging tablets such as drugs using a film such as PVC film is performed as follows. A long film is intermittently and continually unrolled and fed, and is then sandwiched between flat heating plates which are provided opposite each other and can be moved toward and away from each other, for intended heating. The film softened by heating is molded, using a mold, into pockets that accommodate one or more tablets. Thereafter, a tablet or tablets are put into each pocket. The film with pockets is sealed by an aluminum film attached thereto. The resultant film is cut into a number of sheets each of which has a required number of pockets. The drug-containing sheets are a final product.

Incidentally, in the abovementioned conventional film molding by a blister packaging machine, generally, PVC film in the shape of a sheet is continually or intermittently unrolled and fed from a roll thereof, and in association with the unrolling and feeding, the entire surface of the film is heated to a temperature suitable for molding of the film into pockets using a heating device that is disposed opposite both sides of the film and can be moved toward and away from the film. Thereafter, the film is fed into a molding device, in which a portion of the film is in turn molded into desired pockets using a mold. A tablet is put into each pocket. Thereafter, the film is sealed by an aluminum film attached thereto.

Therefore, PVC film is suitable for molding of a portion of the heated film into the desired shape of pockets. However, the entire PVC film is heated for molding, and therefore, the film thickness of the formed pocket, particularly the sheet thickness of a top surface portion thereof, is much thinner than the film thickness of the other portion. After the pockets are filled with tables, two sheets of the film may be put on top of each other, for packaging or sale, with the pocket sides thereof being opposite each other and the pockets of the two sheets being alternately arranged. In that case, the pockets are disadvantageously likely to be deformed.

Polypropylene film is also used to produce a molded blister sheet. However, the polypropylene film sheet has a problem similar to that of the PVC film sheet. That is, the film thickness of the formed pocket, particularly the sheet thickness of a top surface portion of the pocket, is much thinner than that of the other portion. Therefore, after the pockets are filled with tablets, the pockets are disadvantageously likely to be deformed. Furthermore, if the polypropylene film sheet is molded while being entirely heated, the blister sheet after being filled with tablets is warped due to a difference in heat-shrink rate between the polypropylene film sheet and aluminum film. In that case, when two sheets of the film are put on top of each other with the pocket sides thereof being opposite each other for packaging, this cannot be automatically achieved using a machine, and needs to be manually carried out by a worker, disadvantageously resulting in poor work efficiency.

With these disadvantages of heating and molding of a film into pockets using a conventional blister packaging machine in mind, the present applicant has previously proposed a film thermoforming method and device of a blister packaging machine in which molding can be carried out without extreme reduction in the sheet thickness of a top surface portion of the pocket, and without warpage, which allows stacking (see Patent Document 1).

In the proposed film thermoforming method and device of a blister packaging machine, as shown in FIG. 4, a film F that is intermittently unrolled and fed in synchronization with opening and closing drive of molds 5A and 5B of a thermoforming device, is sandwiched and heated between the molds 5A and 5B of the thermoforming device, and the heated film F is partially stretched along inner peripheral surfaces of pocket holes 52 of the forming mold 5A and is thereby molded into pockets.

Specifically, the mold of the thermoforming device is provided with the forming mold 5A having the pocket holes 52, the heating mold 5B having plugs 58a that are disposed opposite the pocket holes 52 of the forming mold 5A and locally heat only pocket molding portions of the film F, and compressed air blowing mechanisms 53a and 55a provided at the forming mold 5A and the heating mold 5B, respectively.

### CITATION LIST

### Patent Literature

Patent Document 1: Japanese Unexamined Patent Application Publication No. 2003-95220

### SUMMARY OF INVENTION

### Technical Problem

Incidentally, the film thermoforming method and device of a blister packaging machine disclosed in Patent Document 1 are provided to achieve the abovementioned desired purposes. It is an object of the present invention to modify the film thermoforming method and device of a blister packaging machine disclosed in Patent Document 1, and thereby provide a film thermoforming device of a blister packaging machine capable of performing stable molding at a high rate while achieving the desired purposes, i.e., molding without extreme reduction in the sheet thickness of a top surface portion of pockets, and molding without warpage, which allows stacking.

### Solution to Problem

To achieve the object, a film thermoforming device of a blister packaging machine according to the present invention comprises: molds of the thermoforming device including a forming mold having a pocket hole, and a heating mold having a plug that locally heats only a pocket-forming portion of a film disposed opposite the pocket hole of the forming mold, and is moved back from a film heating position when the heated film is partially stretched along an inner peripheral surface of the pocket hole of the forming mold so as to be molded into a pocket; and a compressed air blowing mechanism provided at each of the forming mold and the heating mold, wherein a film intermittently fed in synchronization with opening and closing drive of the molds of the thermoforming device, is sandwiched and heated between the molds of the thermoforming device, and the heated film is partially stretched along the inner peripheral surface of the pocket hole of the forming mold to be molded into a pocket, and characterized in that the compressed air blowing mechanism disposed at the forming mold includes a compressed air blowing pore that is open at an inner bottom portion of the pocket hole of the forming mold, and a compressed air blowing pore that is open around the pocket hole of the forming mold.

In this case, the plug of the heating mold may be integrally formed with a plug-formed plate.

A planar heater may be disposed on a back surface of the plug-formed plate.

A packing may be disposed at an outer peripheral portion of the forming mold, surrounding all of the pocket holes, and the film may be sandwiched between the molds of the thermoforming device with the packing interposed therebetween.

### Advantageous Effects of Invention

In the film thermoforming device of the blister packaging machine according to the present invention, the compressed air blowing mechanism disposed at the forming mold includes a compressed air blowing pore that is open at an inner bottom portion of the pocket hole of the forming mold, and a compressed air blowing pore that is open around the pocket hole of the forming mold. Therefore, compressed air is supplied from both of the blowing pores. This allows quick heating of the film. Therefore, stable and fast molding can be carried out while achieving the desired purposes that molding can be carried out without excessive reduction in the sheet thickness of a top surface portion of the pocket, and warpage is prevented and thereby stacking is allowed, as in the conventional thermoforming device of a blister packaging machine disclosed in Patent Document 1.

The plug of the heating mold that is integrally formed with the plug-formed plate can improve heat conduction from the heating mold body to the plug, and thereby quickly heat the film, and therefore, more stable and faster molding can be carried out.

The arrangement of a planar heater on a back surface of the plug-formed plate can reduce variations in the temperatures of the heating mold body and the plug, whereby the film can be quickly and uniformly heated, and therefore, more stable and faster molding can be carried out.

The arrangement of a packing at an outer peripheral portion of the mold, surrounding all of the pocket holes, and the sandwiching of the film between the molds of the thermoforming device with the packing interposed therebetween, can prevent leakage of compressed air, and therefore, more stable and faster molding can be carried out.

### BRIEF DESCRIPTION OF DRAWINGS

FIG. 1 is a diagram for describing an entire blister packaging machine according to the present invention.

FIG. 2 is a cross-sectional view showing main portions of the film thermoforming device of a blister packaging machine according to the present invention.

FIG. 3(A) is a plan view showing molds of the film thermoforming device, FIG. 3(B) is a side cross-sectional view of the molds of the film thermoforming device, and FIG. 3(C) is a side cross-sectional view of main portions of the molds of the film thermoforming device.

FIG. 4 is a cross-sectional view showing main portions of a conventional film thermoforming device of a blister packaging machine.

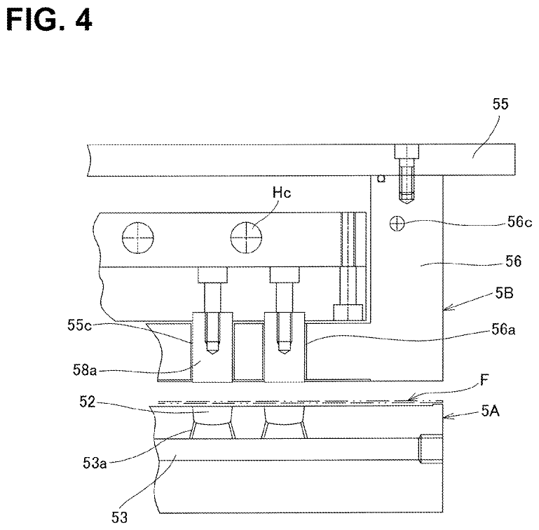

### DESCRIPTION OF EMBODIMENTS

Embodiments of a film thermoforming device in a blister packaging machine according to the present invention will now be described with reference to the accompanying drawings.

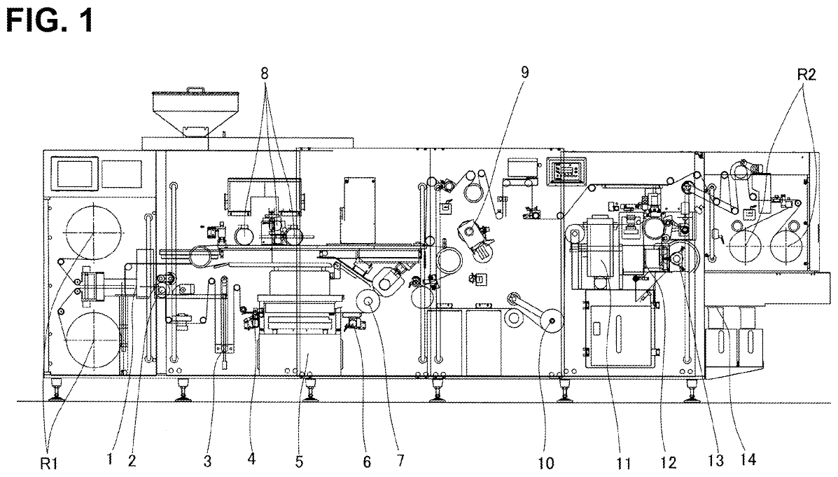

FIGS. 1-3 show an example film thermoforming device of a blister packaging machine according to the present invention.

As shown in FIG. 1, the blister packaging machine is configured to operate as follows. A film F such as polypropylene film is continually unrolled and fed from a film roll R1 of the film F. The film F is fed out by an outfeed roller 2 through a film connection device 1. The tension of the film F is adjusted by a fixed tension roll 3, and thereafter, the film F is intermittently fed to the next thermoforming device 5 by a guide roller 4. In the thermoforming device 5, desired pockets are formed. Thereafter, a tablet is fed to each pocket by a tablet feed device 8 through a guide roller 6 and a molded film conveying roller 7. Thereafter, the film F is sealed with an aluminum film A1 continually unrolled and fed from an aluminum film roll R2 of aluminum film in the shape of a sheet, by a seal roll 9. The film F is passed through a dancer roll 10 and a slitter 11, followed by punching and inscription by a punching/inscribing device 12. Here, the products are separated from scraps. The products are removed through a sheet removal device 13, while the scraps are removed through an empty sheet discharge device 14.

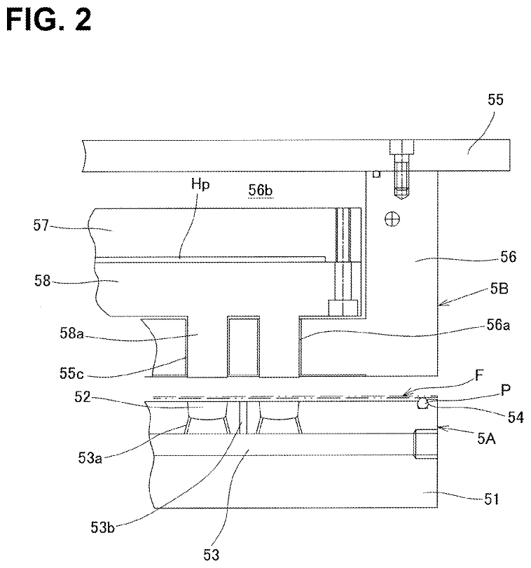

As shown in FIG. 2, in the thermoforming device 5, a forming mold 5A and a heating mold 5B are provided opposite each other and are configured to move toward and away from each other. The film F, which is in the shape of a continuous sheet, is inserted and passed between the forming mold 5A and the heating mold 5B. The intermittent feeding of the film F is synchronized with the approaching and receding movements of the forming mold 5A and the heating mold 5B.

The film F, which is in the shape of a continuous sheet, is substantially horizontally moved between the forming mold 5A and the heating mold 5B, which are opposite each other.

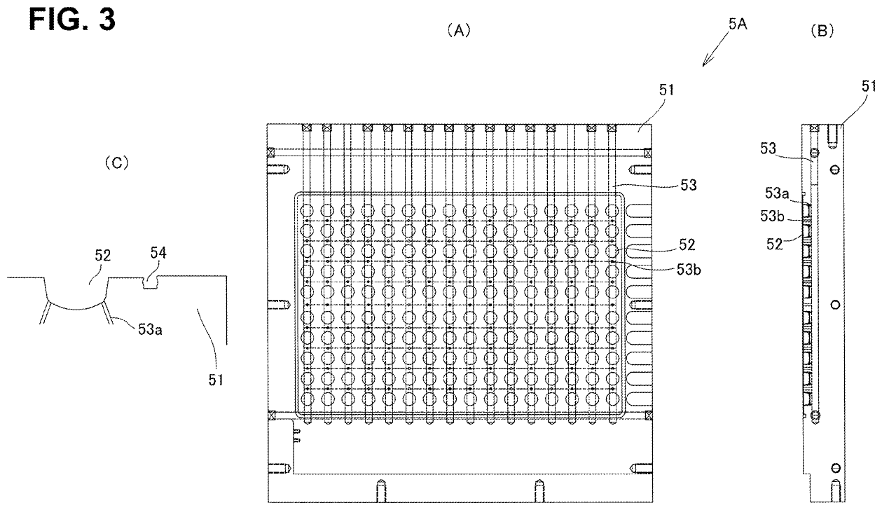

As shown in FIGS. 2 and 3, the forming mold 5A is configured such that a mold body 51 is mounted on a mount base (not shown) which is allowed to relatively move toward and away from the heating mold 5B, which is opposite the forming mold 5A. The mold body 51 is provided with a plurality of recessed pocket holes 52. The pocket holes 52 are aligned and formed such that a plurality of sheets (the number of sheets is not particularly limited, and for example, 8×2 sheets) each of which has, for example, 10-12 pockets (10 pockets in the embodiment shown) for accommodating a plurality of tablets (the number of tablets is not particularly limited, and for example, 10-12 tablets) can be simultaneously molded. A compressed air blowing pore 53a is formed which has an opening at an inner bottom portion of each pocket hole 52 (in the embodiment shown, each pocket hole 52 has two blowing pores 53a). The mold body 51 is also provided with a compressed air supply path 53 which is formed and configured such that compressed air having an adjusted pressure is supplied through the blowing pore 53a.

The shape of the pocket hole 52 is not limited to that shown in the drawings. The compressed air supply path 53, which is in communication with the pocket holes 52 through the compressed air blowing pores 53a, is coupled to a compressed air source (not shown) so that compressed air is synchronously supplied to the plurality of pocket holes 52.

Furthermore, in the forming mold 5A, a compressed air blowing pore 53b, which is open, is formed around each pocket hole 52. Through the blowing pores 53b, compressed air having adjusted pressure is supplied from the compressed air supply path 53, which is shared by the blowing pore 53a.

In the example shown, the blowing pore 53b is formed along the compressed air supply path 53 between each pocket hole 52.

The blowing pore 53b has a diameter greater than that of the blowing pore 53a, which is open at the inner bottom portion of the pocket hole 52. Specifically, for example, the blowing pore 53a has ø0.7, and the blowing pore 53b has ø2. In that case, by supplying a large amount of compressed air through the blowing pores 53b, the film F can be instantaneously pressed against the plugs 58a of the heating mold 5B, and can thereby be quickly heated.

In addition, a groove 54 in which a packing P is disposed is formed at an outer peripheral portion of the forming mold 5A, surrounding all of the pocket holes 52. When the film F is sandwiched between the molds of the thermoforming device with the packing P disposed in the groove 54 interposed between the molds, the leakage of compressed air can be prevented, leading to more stable and faster molding.

Here, the groove 54 in which the packing P is disposed is preferably formed in the shape of a kind of dovetail groove having a narrowed opening. This can reliably prevent dislodging of the packing P even when a load is applied to the packing P during passage of a connection portion of the film F, for example.

As shown in FIG. 2, the heating mold 5B is configured such that the heating mold body 56 is fixed to the mount base 55 by a fastening device such as a bolt, and in the heating mold body 56, a heater base 57 and a plug-formed plate 58 are disposed, and on the plug-formed plate 58, the plurality of protruding plugs 58a are formed opposite the pocket holes 52, which are formed on the forming mold 5A.

A plurality of plug insertion pores 56a are formed on the side of the heating mold body 56 facing the forming mold 5A, and are opposite the pocket holes 52, which are formed on the forming mold 5A. A recess 56b is formed on the back side of the heating mold body 56. The heater base 57 and the plug-formed plate 58 are disposed in the recess 56b.

A water passage path 56c is formed in the shape of a tunnel in the heating mold body 56. Cooling water is circulated in the heating mold body 56 along the water passage path 56c to cool the entire heating mold body 56.

The plugs 58a, which locally heat only pocket-forming portions of the film F, are integrally formed on the plug-formed plate 58, which is a thick plate, at the same positions as those of the plurality of plug insertion pores 56a, opposite the pocket holes 52, which are formed on the forming mold 5A. For example, the plugs 58a are formed by cutting the material for the plug-formed plate 58.

This can improve heat conduction from the plug-formed plate 58 to the plug 58a, compared to the case where a conventional plug 58a is fixed by a screw or the like, and therefore, the film F can be quickly heated, leading to more stable and faster molding.

A planar heater Hp is disposed on the back side of the plug-formed plate 58 between the plug-formed plate 58 and the heater base 57.

This can reduce variations in the temperature of the plug-formed plate 58 and the plugs 58a, compared to a conventional cartridge heater Hc, and therefore, the film can be quickly and uniformly heated, leading to more stable and faster molding.

When the plug-formed plate 58 with the integrally formed plugs 58a is disposed in the recess 56b of the heating mold body 56, each plug 58a is inserted into the corresponding plug insertion pore 56a. In this case, a front end surface of the plug 58a is substantially flush with a surface of the heating mold body 56, and a space 55a is formed between an outer peripheral surface of the plug 58a and an inner peripheral surface of the plug insertion pore 56a. Compressed air for molding is blown from the space 55a toward the inside of the pocket hole 52 of the forming mold 5A.

Next, a method for molding a film into pockets using the film thermoforming device of a blister packaging machine will be described with reference to FIG. 2.

The film F on the film roll R1 is intermittently and continually unrolled and fed from the film roll R1, is passed through the film connection device 1, and is fed out by the outfeed roller 2, in synchronization with opening and closing drive of the thermoforming device 5. At this time, the tension of the film F is adjusted by the fixed-tension roll 3. When a portion having a preset length of the film F is passed through the guide roller 4 and introduced between the forming mold 5A and the heating mold 5B of the thermoforming device 5 as they are opposite each other with a space interposed therebetween, the unrolling and feeding is stopped, and the separate forming mold 5A and heating mold 5B are closed.

At this time, the film F is sandwiched between the forming mold 5A and the heating mold 5B with the packing P disposed at an outer peripheral portion thereof interposed therebetween. The space between the molding surfaces of the forming mold 5A and the heating mold 5B is set to be greater than the film thickness, and therefore, the film F is allowed to freely move by a slight distance in the thickness direction in the space between the molding surfaces of the forming mold 5A and the heating mold 5B.

When the forming mold 5A and the heating mold 5B are closed, compressed air supplied from the compressed air supply path 53, which is provided on the forming mold 5A, is blown from each pocket hole 52 and a surrounding portion through the compressed air blowing pores 53a and 53b, so that the film F is pressed against the molding surface of the heating mold 5B, which is opposite the forming mold 5A. As a result, the film F pressed by the compressed air is pressed against and heated by the front end surface of each plug 58a, which is heated by the planar heater Hp provided in the heating mold 5B through the plug-formed plate 58.

At this time, the heating mold body 56 at an outer peripheral portion of the plug insertion pores 56a, in which the plugs 58a are inserted, is cooled by cooling water flowing in the water passage path 56c. Therefore, the film pressed against the surface of the heating mold 5B at the outer peripheral portion of the plug insertion pores 56a is not heated. Thus, the film F is locally heated at a predetermined temperature.

Next, the supply of compressed air from the compressed air supply path 53, which is provided on the forming mold 5A, is stopped, and the heater base 57 and the plug-formed plate are slightly moved back. Thereafter, compressed air is blown from the space 55a formed between the outer peripheral surface of the plug 58a and the inner peripheral surface of the plug insertion pore 56a. As a result, the film F locally heated is pressed from the direction of the heating mold 5B toward the forming mold 5A.

Here, the heater base 57 and the plug-formed plate 58 are moved by a drive mechanism (not shown) such as an air cylinder.

At this time, only a locally heated and softened portion of the film F is stretched along the inner peripheral surface of the pocket hole 52 of the forming mold 5A, so that a pocket is formed. In particular, the front end surface of the plug 58a is configured to have a diameter slightly greater than the outer peripheral diameter of the pocket hole 52, for example, by about 1 mm, although the present invention is not limited to this. Therefore, the film is stretched to a greater extent at the outer peripheral portion of the pocket hole 52 than at an inner bottom portion of the pocket hole 52. Therefore, the stretching of the film F heated and softened is thicker at the inner bottom portion of the pocket hole 52 than at the inner peripheral surface of the pocket hole 52.

As a result, even when the pocket hole 52 is filled with a tablet, the deformation of the inner bottom portion of the pocket hole 52 can be prevented.

After pockets have been formed on the film F between the forming mold 5A and the heating mold 5B, the two molds are separated from each other. By feeding the next film intermittently, the pocket-forming portion of the film is released from the forming mold 5A, and the next unmolded film is introduced between the forming mold 5A and the heating mold 5B.

In this case, in order to reliably and easily cause the stretching of the heated and softened film to be thinner at the inner peripheral surface of the pocket hole 52 than at the inner bottom portion of the pocket hole 52, the plug-formed plate 58 is moved back so that the front end surface of each plug 58a is separated from the film surface when compressed air is blown from the space 55a.

Thus, only the pocket-forming portion of the film F is locally heated while the surrounding portion thereof is cooled. Therefore, unnecessary heating is not performed on the film F as a whole, which prevents the occurrence of warpage of the film F caused by heating, so that products obtained by filling each pocket with a tablet and cutting the film into sheets can be mechanically put on top of each other.

In particular, by supplying a large amount of compressed air from the blowing pores 53b, which have a diameter greater than that of the blowing pores 53a, which are open at the inner bottom portions of the pocket holes 52, the film F can be instantaneously pressed against the plugs 58a of the heating mold 5B, and can thereby be quickly heated, for example. This allows reduction of cycle time, resulting in more stable and faster molding.

The film thermoforming device of a blister packaging machine according to the present invention has been described by way of example. The present invention is not limited to the configurations described above in the examples. Modifications and changes can be made to the configurations without departing from the scope of the present invention.

### INDUSTRIAL APPLICABILITY

The film thermoforming device of a blister packaging machine according to the present invention has the feature that molding can be carried out without excessive reduction in the sheet thickness of a top surface portion of the pocket, and warpage is prevented and thereby stacking is allowed, and stable and fast molding can be achieved, and therefore, can be suitably used in applications of blister packaging machines.

### REFERENCE SIGNS LIST

Al ALUMINUM FILM
F FILM
Hc CARTRIDGE HEATER
Hp PLANAR HEATER
P PACKING
R1 FILM ROLL
R2 ALUMINUM FILM ROLL
1 FILM CONNECTION DEVICE
2 OUTFEED ROLLER
3 FIXED-TENSION ROLL
4 GUIDE ROLLER
5 THERMOFORMING DEVICE
5A FORMING MOLD
5B HEATING MOLD
51 MOLD BODY
52 POCKET HOLE
53 COMPRESSED AIR SUPPLY PATH
53a COMPRESSED AIR BLOWING PORE (COMPRESSED AIR BLOWING MECHANISM)
53b COMPRESSED AIR BLOWING PORE (COMPRESSED AIR BLOWING MECHANISM)
54 GROOVE
55 HEATING MOLD MOUNT BASE
55a SPACE (COMPRESSED AIR BLOWING MECHANISM)
56 HEATING MOLD BODY
56a PLUG INSERTION PORE
56b RECESS
56c WATER PASSAGE PATH
57 HEATER BASE
58 PLUG-FORMED PLATE
58a PLUG
6 GUIDE ROLLER
7 MOLDED FILM CONVEYING ROLLER
8 TABLET FEED DEVICE
9 SEAL ROLL
10 DANCER ROLL
11 SLITTER
12 PUNCHING/INSCRIBING DEVICE
13 SHEET REMOVAL DEVICE
14 EMPTY SHEET DISCHARGE DEVICE

1. A film thermoforming device of a blister packaging machine, the film thermoforming device comprising: molds of the thermoforming device including a forming mold having a pocket hole, and a heating mold having a plug that locally heats only a pocket-forming portion of a film disposed opposite the pocket hole of the forming mold, and is moved back from a film heating position when the heated film is partially stretched along an inner peripheral surface of the pocket hole of the forming mold so as to be molded into a pocket; and a compressed air blowing mechanism provided at each of the forming mold and the heating mold, wherein a film intermittently fed in synchronization with opening and closing drive of the molds of the thermoforming device, is sandwiched and heated between the molds of the thermoforming device, and the heated film is partially stretched along the inner peripheral surface of the pocket hole of the forming mold to be molded into a pocket, and characterized in that the compressed air blowing mechanism disposed at the forming mold includes a compressed air blowing pore that is open at an inner bottom portion of the pocket hole of the forming mold, and a compressed air blowing pore that is open around the pocket hole of the forming mold, and the compressed air blowing pore that is open around the pocket hole of the forming mold has a diameter greater than that of the compressed air blowing pore that is open at the inner bottom portion of the pocket hole.

2. The film thermoforming device according to claim 1, characterized in that the plug of the heating mold is integrally formed with a plug-formed plate by cutting a material for the plug-formed plate.

3. The film thermoforming device according to claim 2, characterized in that a planar heater is disposed on a back surface of the plug-formed plate.

4. The film thermoforming device according to claim 1, characterized in that a groove formed in the shape of a dovetail groove having a narrowed opening is disposed at an outer peripheral portion of the forming mold, surrounding all of the pocket holes, a gasket is disposed in the groove, and the film is sandwiched between the molds of the thermoforming device with the gasket interposed therebetween.

5. The film thermoforming device according to claim 2, characterized in that a groove formed in the shape of a dovetail groove having a narrowed opening is formed at an outer peripheral portion of the forming mold, surrounding all of the pocket holes, a gasket is disposed in the groove, and the film is sandwiched between the molds of the thermoforming device with the gasket interposed therebetween.

6. The film thermoforming device according to claim 3, characterized in that a groove formed in the shape of a dovetail groove having a narrowed opening is formed at an outer peripheral portion of the forming mold, surrounding all of the pocket holes, a gasket is disposed in the groove, and the film is sandwiched between the molds of the thermoforming device with the gasket interposed therebetween.
